(19) United States
(12) Patent Application Publication
(10) Pub. No.: US 2026/0215445 A1
(43) Pub. Date: Jul. 30, 2026

(54) COMBI OVEN WITH SMOKING FUNCTION

(71) Applicant: Zhejiang Fudeer Electric Appliance Co., Ltd., Taizhou (CN)

(72) Inventors: Meide JIANG, Taizhou (CN); Junhua JIANG, Taizhou (CN)

(21) Appl. No.: 19/097,938

(22) Filed: Apr. 2, 2025

(30) Foreign Application Priority Data
Jan. 24, 2025 (CN) 202520172651.2

(51) Int. Cl. A23B 4/052; A23B 4/056; A47J 37/06; F24C 7/06; F24C 15/00

(52) U.S. Cl. CPC A23B 4/0526; A23B 4/056; A47J 37/0629; A47J 37/0664; F24C 7/062; F24C 15/008

(57) ABSTRACT

A combi oven with smoking function includes an oven body, an oven door, a plurality of grills, a heating assembly and a plurality of rollers. The oven body is provided with a heating chamber on a side in a horizontal direction, the oven door is connected to the oven body and covers an opening of the heating chamber, the plurality of grills are slidably arranged in the heating chamber in the horizontal direction, the plurality of grills are distributed at intervals in a vertical direction, the heating assembly is located in the heating chamber closer to a bottom of the heating chamber, the plurality of rollers are connected to a lower end of the oven body, and the plurality of rollers are distributed at intervals circumferentially along the oven body.

### CROSS-REFERENCE TO RELATED APPLICATION

This application claims the priority to Chinese patent application serial no. 202520172651.2, filed on January 24, 2025. The entirety of Chinese patent application serial no. 202520172651.2 is hereby incorporated by reference herein and made a part of this specification.

### TECHNICAL FIELD

The present application relates to the technical field of household appliances, and in particular, to a combi oven with smoking function.

### BACKGROUND ART

Combi ovens, which are used for steaming or baking food, are increasingly used by people, who sometimes need to cook and heat liquid ingredients using same.

Conventional combi ovens are classified into countertop combi ovens and built-in combi ovens, a countertop combi oven has a smaller capacity but are convenient to transport, while a built-in combi oven has a larger capacity but are inconvenient to transport due to large mass, and cannot meet the demands for steaming and baking large quantities of food outdoors.

### SUMMARY

In order to improve the capacity and ease of transportation of a combi oven, and meet the demands for steaming and baking large quantities of food, the present application provides a combi oven with smoking function.

The combi oven with smoking function of the present application includes an oven body, an oven door, a plurality of grills, a heating assembly and a plurality of rollers, the oven body is provided with a heating chamber on a side in a horizontal direction, the oven door is connected to the oven body and covers an opening of the heating chamber, the plurality of grills are slidably arranged in the heating chamber in the horizontal direction, the plurality of grills are distributed at intervals in a vertical direction, the heating assembly is located in the heating chamber closer to a bottom of the heating chamber, the plurality of rollers are connected to a lower end of the oven body, and the plurality of rollers are distributed at intervals circumferentially along the oven body.

By using the above-mentioned technical solution, the plurality of grills are provided so as to increase or decrease a quantity of grills according to needs, and rollers are connected to the oven body so as to facilitate the transportation of the combi oven and meet the demands for steaming and baking large quantities of food.

The combi oven with smoking function further includes a handle, where the handle is connected to a side of the oven body away from the oven door, a plurality of support bases are connected to the lower end of the oven body, the plurality of support bases are distributed at intervals circumferentially along the oven body, the plurality of rollers are connected to a group of support bases of the plurality of support bases away from the oven door respectively on sides of the group of support bases away from the oven door, and a rotation axis of each of the plurality of rollers is horizontal.

By using the above-mentioned technical solution, the rollers are located on a side of the oven body away from the oven door. When the oven must be moved, the handle is pulled so that an upper end of the combi oven main unit is inclined away from the oven door, so that the rollers abut against the ground, so as to move the combi oven as the rollers roll. And after moving to a designated position, the combi oven is placed vertically, so that the rollers are separated from the ground, and the combi oven is relatively fixed to the ground.

The combi oven with smoking function further includes a gas outlet tube, where a lower end of the gas outlet tube extends into the heating chamber, an upper end of the gas outlet tube protrudes out of the oven body, a gas inlet is formed at an outer periphery of the lower end of the gas outlet tube, and the gas inlet is configured to connect an inside and an outside of the gas outlet tube.

By using the above-mentioned technical solution with the gas outlet tube, which is configured with the gas inlet at a periphery of the end thereof extending into the heating chamber, so as to facilitate the discharge of the waste air in the heating chamber, and prevent the waste air from liquefying on the chamber wall of the heating chamber and dripping on to the food on the grills.

The combi oven with smoking function further includes an adjustment plate and a fixing plate, where the fixing plate is coaxially embedded in the gas outlet tube, a side wall of the fixing plate fits against an inner wall of the gas outlet tube, the fixing plate is configured with a plurality of first gas outlet holes, the plurality of first gas outlet holes are uniformly distributed around an axis of the fixing plate, the adjustment plate is coaxially and rotatably embedded in the gas outlet tube, a side wall of the adjustment plate fits against the inner wall of the gas outlet tube, the adjustment plate fits against the fixing plate, the adjustment plate is configured with a plurality of second gas outlet holes, a quantity of the plurality of second gas outlet holes is equal to a quantity of the plurality of first gas outlet holes, the plurality of second gas outlet holes correspond to the plurality of first gas outlet holes one-to-one, and the plurality of second gas outlet holes are used to communicate with the plurality of first gas outlet holes.

By using the above-mentioned technical solution, the adjustment plate is rotated to change an overlapping area of the first gas outlet holes and the second gas outlet holes, so as to change the gas output of the gas outlet tube, thereby satisfying different usage requirements, and thus improving the applicable range of the combi oven.

The combi oven with smoking function further includes an adjustment lever located on a side of the fixing plate close to the heating chamber, the fixing plate is configured with an arc-shaped groove, an axis of the arc-shaped groove coincides with a rotation axis of the adjustment plate, the adjustment lever is slidably arranged in the arc-shaped groove, one end of the adjustment lever is connected to the adjustment plate after passing through the arc-shaped groove.

By using the above-mentioned technical solution, the fixing plate is provided with the arc-shaped groove, and the adjustment lever is connected with the adjustment plate after passing through the arc-shaped groove, so as to rotate the adjustment plate via the adjustment plate and improve the convenience of the adjustment of the adjustment plate.

The combi oven with smoking function further includes a power board assembly, where the heating assembly include an electric heating tube and a heat spreader above the electric heating tube, the electric heating tube and the heat spreader are both arranged in the heating chamber, the power board assembly is connected to the oven body, and the power board assembly is electrically connected to the electric heating tube.

By using the above-mentioned technical solution, the power board assembly is provided to energize an electric heating tube, and heat generated by the electric heating tube is uniformly distributed into the heating chamber via a heat spreader, so that food in each area in the heating chamber is heated.

The combi oven with smoking function further includes a smoking box, where the smoking box is connected to the heat spreader under the heat spreader, and the smoking box is provided with a spice storage chamber.

By using the above-mentioned technical solution, the smoking box is connected to the heat spreader thereunder, the spice is placed in the smoking box. When the electric heating tube works, the generated steam carries the spice in the storage chamber to each area in the heating chamber, so as to flavor the food, thereby improving the convenience of the combi oven.

The combi oven with smoking function further includes an illuminating lamp, where the illuminating lamp is arranged in the heating chamber, and the illuminating lamp is electrically connected to the power board assembly.

By using the above-mentioned technical solution, the illuminating lamp is provided, so that a user may observe the shape and color of food above the grill and judge the state of the food at night or in an environment with poor lighting conditions.

The combi oven with smoking function further includes a water tank and an evaporation tray assembly, where the water tank is connected to the oven body, the water tank is provided with a liquid storage chamber, the evaporation tray assembly is connected to the oven body, one end of the evaporation tray assembly extends into the liquid storage chamber, the evaporation tray assembly communicates with the heating chamber via a conduit, and the evaporation tray assembly is electrically connected to the power board assembly.

By using the above-mentioned technical solution, the liquid in the liquid storage chamber is converted into a gas by the evaporation tray assembly and then transferred into the heating chamber, the humidity in the heating chamber is ensured, the possibility that food gets burnt is reduced, and the reliability of the oven is improved.

The combi oven with smoking function further includes a grease collection tray, where the grease collection tray is connected to the lower end of the oven body, the grease collection tray is provided with an oil storage chamber, the bottom of the heating chamber is configured with an oil discharge outlet, the oil discharge outlet communicates with the oil storage chamber, and a chamfer is formed at an inner wall of the oil discharge outlet at an end of the oil discharge outlet away from the grease collection tray.

By using the above-mentioned technical solution, the grease collection tray is provided, the oil discharge outlet is defined at the bottom of the heating chamber, the inner wall of the end of the oil discharge outlet away from the grease collection tray is formed with a chamfer, so that the oil stain at the bottom of the heating chamber converges into the oil discharge outlet, and falls into the oil storage chamber through the oil discharge outlet, so that the oil produced by steaming and baking food may be collected and cleaned easily.

In summary, the present application includes at least one of the following beneficial technical effects:

1. The plurality of grills are provided so as to increase or decrease the quantity of grills according to needs, and rollers are connected to the oven body so as to facilitate the transportation of the combi oven and meet the demands for steaming and baking large quantities of food outdoors.

2. The gas outlet tube is provided, which is configured with the gas inlet at a periphery of the end thereof extending into the heating chamber, so as to facilitate the discharge of the waste air in the heating chamber. The adjustment plate is rotated to change an overlapping area of the first gas outlet holes and the second gas outlet holes, so as to change the gas output of the gas outlet tube, thereby satisfying different usage requirements, and thus improving the applicable range of the combi oven.

3. The power board assembly is provided to energize the electric heating tube, and heat generated by the electric heating tube is uniformly distributed into the heating chamber via a heat spreader, so that food in each area in the heating chamber is heated.

### BRIEF DESCRIPTION OF THE DRAWINGS

FIG. 1 is a sectional view of a combi oven with smoking function.

FIG. 2 is an enlarged view of A in FIG. 1.

FIG. 3 is a schematic structural diagram illustrating a combi oven with smoking function.

FIG. 4 is a schematic structural diagram illustrating a combi oven with smoking function from another perspective.

FIG. 5 is a schematic structural diagram illustrating a combi oven with smoking function.

FIG. 6 is a partial schematic structural diagram illustrating a combi oven with smoking function.

FIG. 7 is an exploded schematic structural diagram illustrating a mounting frame, a water tank, a second seal ring, a grease collection tray, a power board assembly, and an evaporation tray assembly.

FIG. 8 is an exploded schematic structural diagram illustrating a mounting frame, a water tank, a second seal ring and a grease collection tray.

FIG. 9 is a partial sectional view of a combi oven with smoking function.

FIG. 10 is an exploded schematic structural diagram illustrating a mounting rod, a hoop, a heating assembly and a smoking box.

FIG. 11 is a partial sectional view showing a combi oven with smoking function, mainly showing an illuminating lamp.

FIG. 12 is an enlarged view at B in FIG. 1.

FIG. 13 is a partial schematic structural diagram illustrating a combi oven with smoking function, mainly showing a gas outlet assembly.

### DETAILED DESCRIPTION

The present application is described in further detail below referring to the figures.

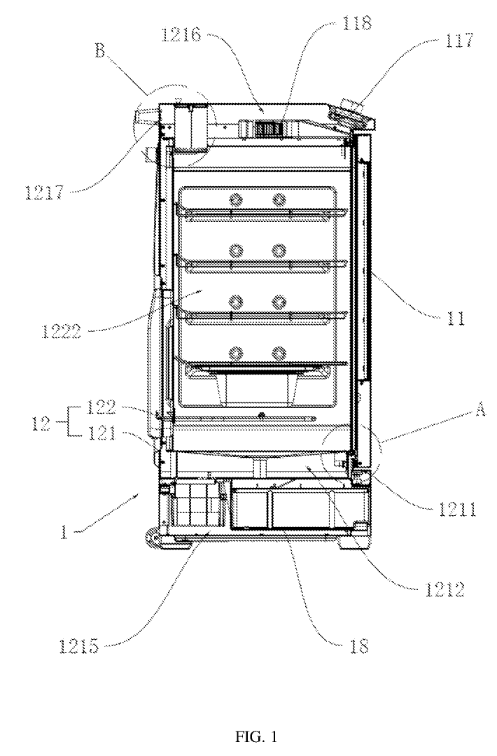

Referring to FIG. 1, the combi oven with smoking function disclosed in an embodiment of the present application includes a combi oven main unit 1, where the combi oven main unit 1 includes an oven body 12, the oven body 12 includes an outer shell 121 and an inner shell 122, the outer shell 121 is configured with an embedding groove 1211 along a side of the outer shell 121 in the width direction of the outer shell, the outer shell 121 is provided with a middle housing cavity 1212, and the inner shell 122 is embedded in the middle housing cavity 1212.

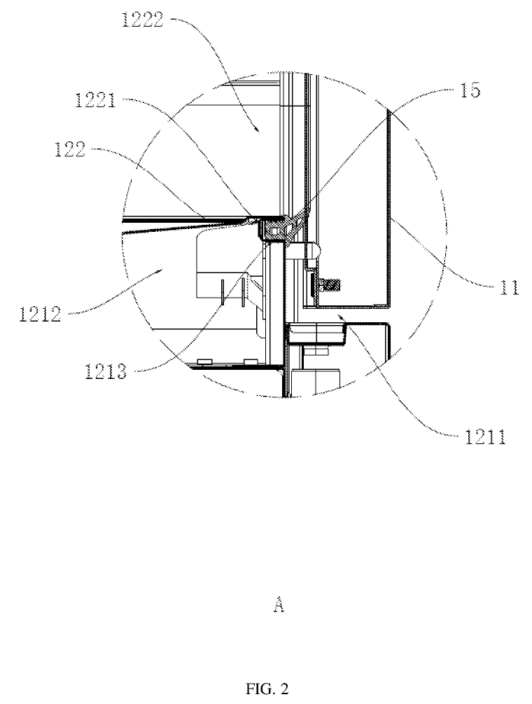

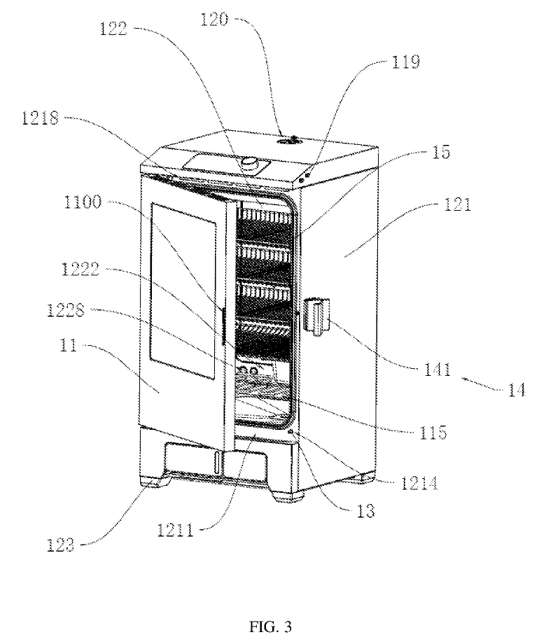

Referring to FIGS. 2 and 3, the combi oven main unit 1 further includes an oven door 11 and a first seal ring 15, a first communication groove 1213 in communication with the middle housing cavity 1212 is defined at the bottom of the embedding groove 1211, a plurality of mounting plates 1221 are fixedly connected to an outer periphery of the inner shell 122, the plurality of mounting plates 1221 are distributed at intervals circumferentially along the inner shell 122, and the mounting plates 1221 are in contact with a cavity wall at a side of the middle housing cavity 1212 close to the embedding groove 1211. The inner shell 122 is formed with a heating chamber 1222 on a side close to the embedding groove 1211, the oven door 11 is embedded in the embedding groove 1211 and covers the opening of the heating chamber 1222. One end of the oven door 11 in the width direction thereof is rotatably connected to a side of the outer shell 121 in the length direction thereof. The first seal ring 15 is embedded in the first communication groove 1213, an inner wall of the first seal ring 15 is in contact with an outer wall of the inner shell 122, an outer wall of the first seal ring 15 is in contact with a groove wall of the first communication groove 1213, and a surface of a side of the first seal ring 15 away from the middle housing cavity 1212 abuts against a surface of a side of the oven door 11 close to the heating chamber 1222.

Referring to FIG. 3, the combi oven main unit 1 further includes a door limit switch 13 and a mounting assembly 14. A reduced hole 1214 is formed at the bottom of the embedding groove 1211 and communicates with the middle housing cavity 1212, the door limit switch 13 is embedded in the reduced hole. One end of the door limit switch 13 extends into the embedding groove 1211 through the reduced hole 1214, and the door limit switch 13 is used for abutting against a surface of a side of the oven door 11 close to the heating chamber 1222. The mounting assembly 14 includes a latch 141 connected to an outer shell 121, a snap-fit slot 1100 is defined on a surface of a side of the oven door 11 away from the heating chamber 1222 and is located on a side of the oven door 11 close to the latch 141. The latch 141 is embedded in the snap-fit slot 1100 to fix the oven door 11 relative to the outer shell 121.

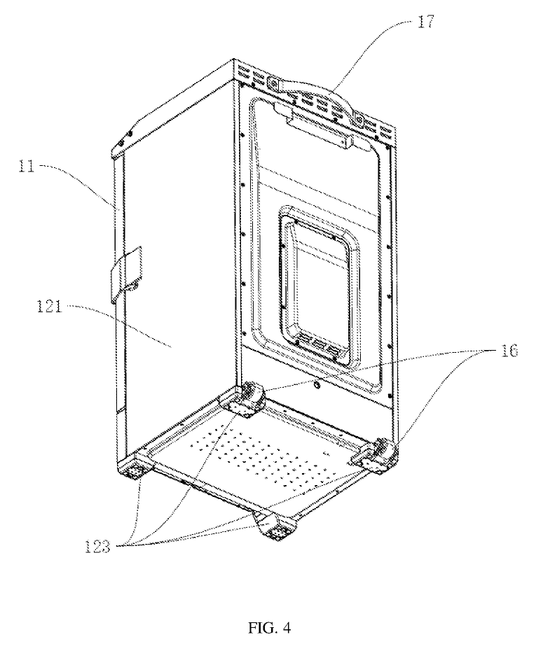

Referring to FIGS. 3 and 4, the oven body 12 further includes a plurality of support bases 123 fixedly connected to a lower end of the outer shell 121, the plurality of support bases 123 are distributed at intervals circumferentially along the outer shell 121. In the present embodiment, four support bases 123 are provided and are distributed at four corners of the outer shell 121. The combi oven main unit 1 further includes rollers 16 and a handle 17, where the rollers 16 are rotatably connected to the support bases 123 at a side away from the oven door 11, a rotation axis of the roller 16 is parallel to the length direction of the outer shell 121, and two rollers 16 are provided and respectively correspond to two support bases 123. The handle 17 is fixedly connected to a side of the outer shell 121 away from the oven door 11, and the handle 17 is located on a side of the outer shell 121 away from the support base 123.

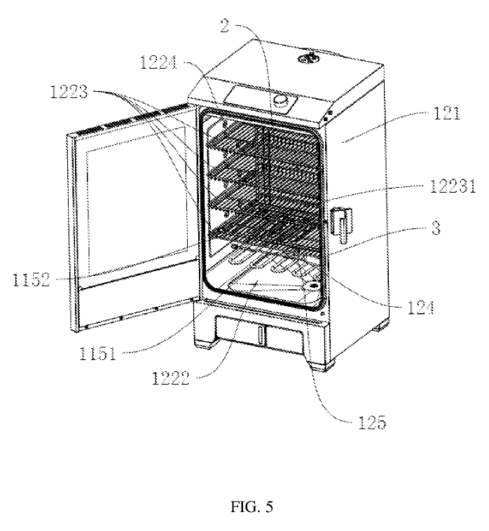

Referring to FIG. 5, a plurality of support rails 1223 are fixedly connected at the chamber wall of the heating chamber 1222, the length direction of the support rails 1223 is parallel to the width direction of the outer shell 121, the plurality of support rails 1223 are divided into two groups, the two groups of support rails 1223 are symmetrically distributed in the length direction of the outer shell 121, and the same one group of support rails 1223 are distributed at intervals along the vertical direction. In the present embodiment, eight support rails 1223 are provided, and the same one group of four support rails 1223 are evenly distributed in the vertical direction. The heating chamber 1222 is fixedly connected to stop blocks 1224 at the chamber wall, one support rail 1223 corresponds to two stop blocks 1224. The two stop blocks 1224 are distributed at intervals in the length direction of the support rail 1223 and are located above the support rail 1223.

The combi oven with smoking function further includes a plurality of grills 2, which are distributed at intervals in the vertical direction. The grills 2 are slidably arranged in the heating chamber 1222 in a sliding direction parallel to the length direction of the support rails 1223, and two ends of the grill 2 at the lower surface thereof are slidably in contact with an upper surface of the support rail 1223.

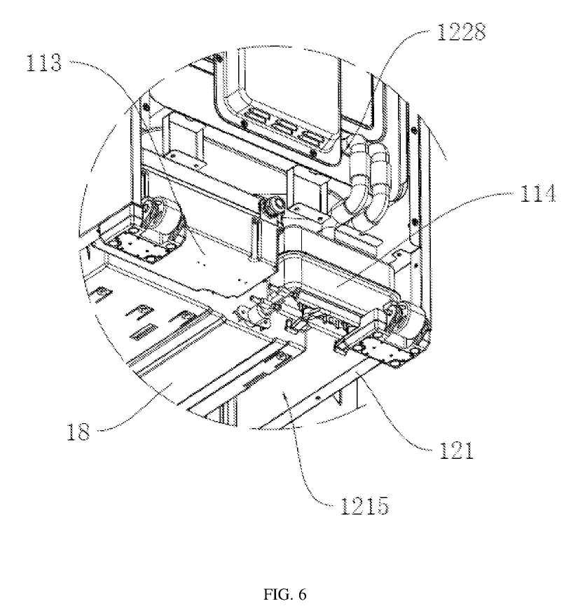

Referring to FIGS. 1 and 6, a lower housing cavity 1215 is formed at a side of the outer shell 121 close to the oven door 11 and is located below the middle housing cavity 1212. The combi oven main unit 1 further includes a mounting frame 18 embedded in the lower housing cavity 1215.

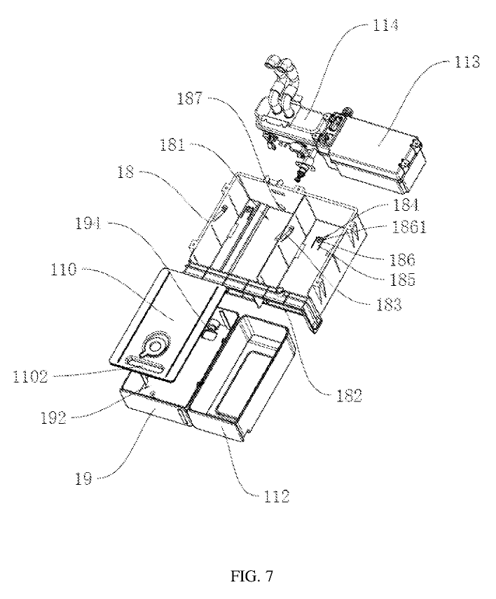

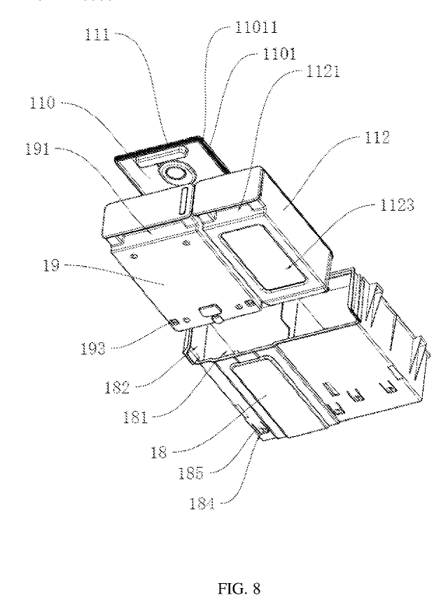

Referring to FIGS. 7 and 8, the combi oven main unit 1 further includes a water tank 19, a cover plate 110, a second seal ring 111, and a grease collection tray 112. Two mounting slots 181 are formed at an upper end of the mounting frame 18 and are distributed at intervals in the length direction of the outer shell 121. A slot wall on a side of the mounting slot 181 close to the oven door 11 is formed with a second communication groove 182 in communication with the outside. The water tank 19 and the grease collection tray 112 are slidably arranged in two mounting slots 181 respectively in a sliding direction parallel to the width direction of the outer shell 121. The grease collection tray 112 is located in the mounting slot 181 close to the latch 141. A first grip groove 191 is formed at a lower end of the water tank 19 on a side close to the second communication groove 182, and a second grip groove 1121 is formed at the lower end of the grease collection tray 112 on a side close to the second communication groove 182. The water tank 19 is formed with a liquid storage chamber 192, and the cover plate 110 is connected to the water tank 19 to cover an opening of the liquid storage chamber 192. A third grip groove 1102 is formed on the cover plate 110 on a side close to the second communication groove 182. An embedded ring 1101 is fixedly connected to the cover plate 110 on a side close to the liquid storage chamber 192 and extends into the liquid storage chamber 192. An annular slot 11011 is formed to surround the embedded ring 1101 with a second seal ring 111 therein, and the outer wall of the second seal ring 111 abuts against the chamber wall of the liquid storage chamber 192. A pressure bar 183 is fixedly connected to the bottom of the mounting slot 181 on one side in the length direction of the outer shell 121, and one end of the pressure bar 183 away from the second communication groove 182 is inclined to the bottom of the mounting slot 181. The lower end of the pressure bar 183 abuts against a surface of the grease collection tray 112 and the cover plate 110 away from the bottom of the mounting slot 181. Two through slots 184 which are symmetrically distributed in the length direction of the outer shell 121 are formed at the bottom of the mounting slot 181. A connecting bar 185 is fixedly connected to a slot wall of the through slot 184 close to the second communication groove 182, a fixing block 186 is fixedly connected to a surface of the other end of the connecting bar 185 close to the mounting slot 181, and a rounded corner 1861 is formed at an outer periphery of one end of the fixing block 186 away from the connecting bar 185. A first fixing slot 193 is defined on the water tank 19 on a side close to the mounting slot 181, and a second fixing slot 1123 is defined on the grease collection tray 112 on a side close to the bottom of the mounting slot 181. The rounded corner 1861 is configured for abutting against an end of the water tank 19 away from the first grip groove 191 and an end of the grease collection tray 112 away from the second grip groove 1121. The fixing block 186 is configured for being embedded in the first fixing slot 193 and the second fixing slot 1123.

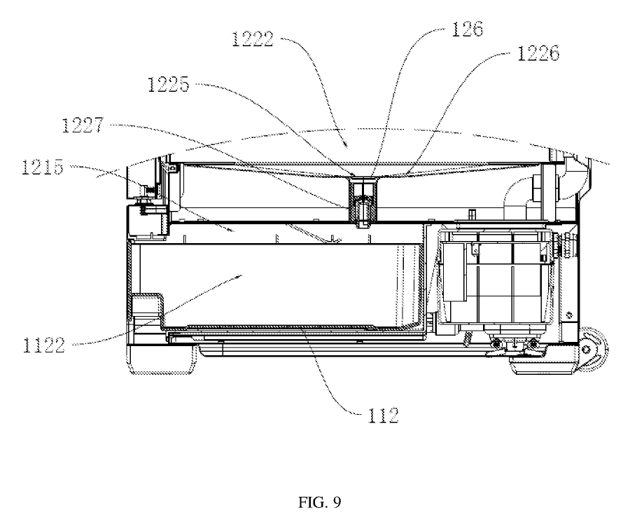

Referring to FIG. 9, the grease collection tray 112 is formed with an oil storage chamber 1122. The heating chamber 1222 is configured with an oil discharge outlet 1225 at the bottom. An oil discharge tube 1227 is fixedly connected to the lower end of the inner shell 122, an axis of the oil discharge tube 1227 coincides with an axis of the oil discharge outlet 1225. The lower end of the oil discharge tube 1227 extends into the lower housing cavity 1215, the oil discharge tube 1227 is aligned with the oil storage chamber 1122, and a filter plate 126 is embedded in the oil discharge tube 1227. A chamfer 1226 is formed at the inner wall of the oil discharge outlet 1225 away from the grease collection tray 112, and the outer wall of the filter plate 126 is in contact with an inner wall of the oil discharge outlet 1225.

Referring to FIGS. 6 and 7, the combi oven main unit 1 further includes a power board assembly 113 and an evaporation tray assembly 114. The power board assembly 113 and the evaporation tray assembly 114 are both embedded in the lower housing cavity 1215, and the power board assembly 113 and the evaporation tray assembly 114 are located on a side of the mounting frame 18 away from the second communication groove 182. The evaporation tray assembly 114 is located on a side of the power board assembly 113 close to the water tank 19, and the evaporation tray assembly 114 and the power board assembly 113 are electrically connected with each other. A first communication hole 187 is formed at a slot wall of the mounting slot 181 away from the second communication groove 182, a second communication hole 194 is formed at a chamber wall of the liquid storage chamber 192, and one end of the evaporation tray assembly 114 extends into the liquid storage chamber 192 after passing through the first communication hole 187 and the second communication hole 194.

Referring to FIGS. 3 and 6, the heating chamber 1222 is formed with a third communication hole 1228 at the chamber wall away from the oven door 11, the third communication hole 1228 is located close to the bottom of the heating chamber 1222, and the evaporation tray assembly 114 communicates with the third communication hole 1228 via a conduit.

Referring to FIGS. 3 and 5, the combi oven main unit 1 further includes a heating assembly 115 including an electric heating tube 1151 and a heat spreader 1152. The support rail 1223 close to the bottom of the heating chamber 1222 is formed with a recess 12231 on a side away from the bottom of the heating chamber 1222, the recess 12231 is located on the side of the support rail 1223 close to the other group of support rails 1223, and two ends of the heat spreader1152 in its length direction are embedded in two recesses 12231 respectively. The oven body 12 further includes a mounting rod 124 and a hoop 125. The length direction of the mounting rod 124 is parallel to the length direction of the outer shell 121. Two ends of the mounting rod 124 are respectively fixedly connected to two side chamber walls of the heating chamber 1222 in the length direction of the outer shell 121. The mounting rod 124 is located below the heat spreader1152, the electric heating tube 1151 is located below the mounting rod 124, the electric heating tube 1151 is electrically connected to the power board assembly 113, and the electric heating tube 1151 is S-shaped. A hoop 125 is sleeved over a periphery of the heating tube, the hoop 125 is fixedly connected to the outer periphery of the mounting rod 124, and a plurality of hoops 125 are provided and distributed at intervals in the length direction of the mounting rod 124. In the present embodiment, three hoops 125 are provided and are evenly distributed along the length direction of the mounting rod 124.

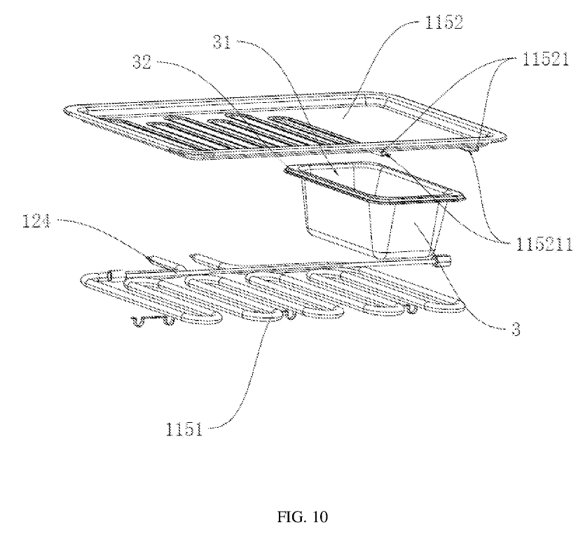

Referring to FIGS. 5 and 10, the combi oven with smoking function further includes a smoking box 3, a connecting frame 11521 is fixedly connected to a side of the heat spreader1152 close to the electric heating tube 1151, two connecting frames 11521 are provided and are symmetrically distributed along the axial direction of the mounting rod 124. A sliding groove 115211 is formed at one end of the connecting frame 11521 close to the oven door 11, where the sliding groove 115211 extends in a direction perpendicular to the axial direction of the mounting rod 124 and is located on a side of one connecting frame 11521 close to the other connecting frame 11521, and a side of the sliding groove 115211 away from the electric heating tube 1151 extends through the connecting frame 11521. A stop ring 32 is fixedly connected to a periphery of the smoking box 3 on an end away from the electric heating tube 1151 and is slidably embedded in two sliding grooves 115211. A surface of the stop ring 32 close to the electric heating tube 1151 is in contact with a slot wall of the sliding groove 115211 close to the electric heating tube 1151. A spice storage chamber 31 is provided at an end of the smoking box 3 away from the electric heating tube 1151.

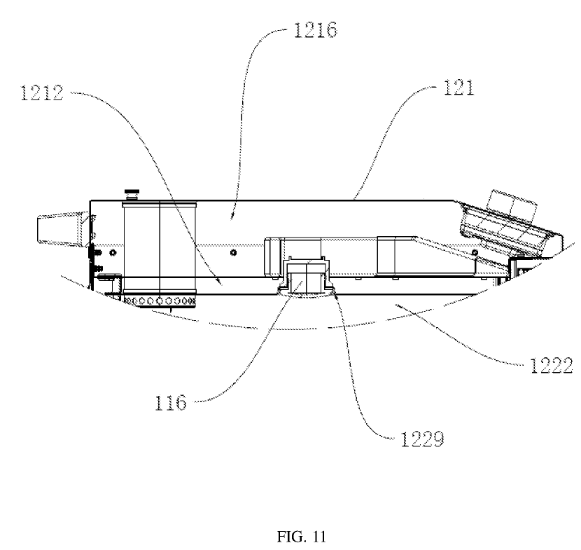

Referring to FIG. 11, the outer shell 121 is provided with an upper housing cavity 1216 above the middle housing cavity 1212. The combi oven main unit 1 further includes an illuminating lamp 116, an upper chamber wall of the heating chamber 1222 is provided with a containment groove 1229, the illuminating lamp 116 is embedded in the containment groove 1229, an upper end of the illuminating lamp 116 extends into the upper housing cavity 1216, and the illuminating lamp 116 is electrically connected to the power board assembly 113.

Referring to FIGS. 1 and 3, the combi oven main unit 1 further includes a control panel 117 embedded in the upper housing cavity 1216 and a heat dissipation fan 118 embedded in the upper housing cavity 1216. The control panel 117 is located at a side of the outer shell 121 close to the oven door 11. A plurality of air inlets 1217 are uniformly distributed at a side cavity wall of the upper housing cavity 1216 away from the oven door 11, and the air inlets 1217 communicate with the outside. An air outlet 1218 is formed at a cavity wall of the upper housing cavity 1216 close to the oven door 11, the air outlet 1218 communicates with the outside. A plurality of air outlets 1218 are provided, and the plurality of air outlets 1218 are distributed at intervals in the length direction of the outer shell 121. In the present embodiment, four air outlets 1218 are provided and evenly distributed along the length direction of the outer shell 121, and the outlet of the heat dissipation fan 118 communicates with the air outlets 1218. A meat probe socket 119 is formed on a side of the outer shell 121 in the length direction thereof close to the latch 141, and the meat probe socket 119 is used for connecting a meat temperature probe to detect the temperature of food in the heating chamber 1222. In the present embodiment, two meat probe sockets 119 are provided.

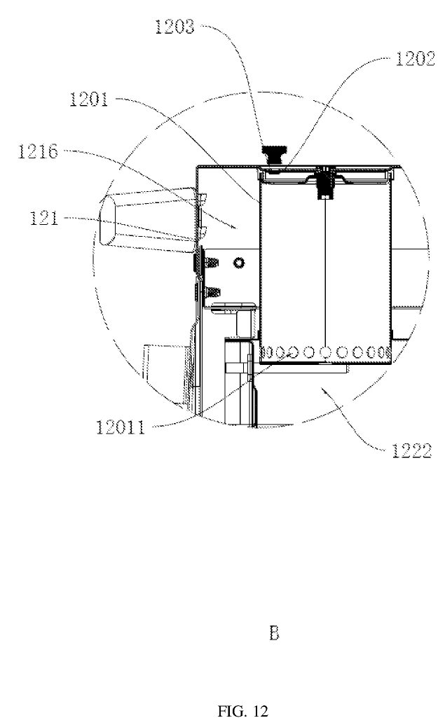

Referring to FIGS. 3 and 12, the combi oven main unit 1 further includes a gas outlet assembly 120 including a gas outlet tube 1201, a fixing plate 1202, and an adjustment plate 1203, a lower end of the gas outlet tube 1201 is inserted into the heating chamber 1222, and the other end of the gas outlet tube 1201 passes through the upper housing cavity 1216 and protrudes out of the outer shell 121. A plurality of gas inlets 12011 are formed in an outer wall of the gas outlet tube 1201 located in the heating chamber 1222 and configured to connect the inner and outer sides of the gas outlet tube 1201. The plurality of gas inlets 12011 are uniformly distributed around an axis of the gas outlet tube 1201. The fixing plate 1202 is embedded in the gas outlet tube 1201 and is located at an end of the gas outlet tube 1201 away from the heating chamber 1222, and an outer wall of the fixing plate 1202 is in contact with an inner wall of the gas outlet tube 1201. The adjustment plate 1203 is rotatably embedded in the gas outlet tube 1201, a rotation axis of the adjustment plate 1203 coincides with the axis of the gas outlet tube 1201, and a surface of the adjustment plate 1203 away from the heating chamber 1222 is in contact with a surface of the fixing plate 1202 close to the heating chamber 1222.

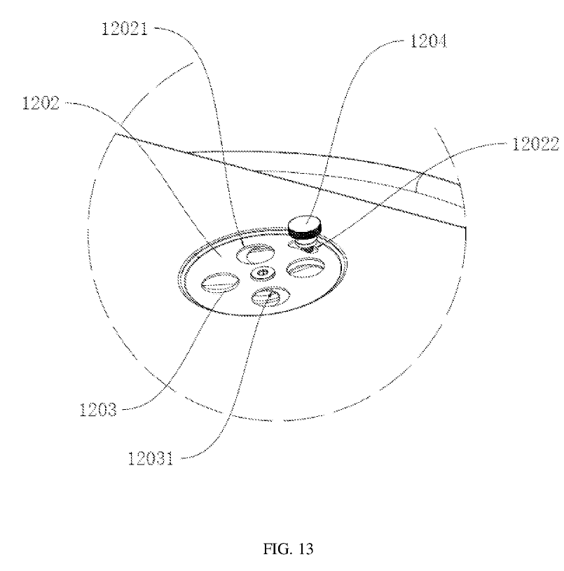

Referring to FIG. 13, the fixing plate 1202 is formed with a plurality of first gas outlet holes 12021 distributed at intervals around the rotation axis of the adjustment plate 1203. In the present embodiment, four first gas outlet holes 12021 are provided. The adjustment plate 1203 is formed with a plurality of second gas outlet holes 12031, a quantity of the second gas outlet holes 12031 is the same as a quantity of the first gas outlet holes 12021, and the second gas outlet holes correspond to the first gas outlet holes one-to-one. The distance from the axis of the second gas outlet hole 12031 to the rotation axis of the adjustment plate 1203 is equal to the distance from the axis of the first gas outlet hole 12021 to the rotation axis of the adjustment plate 1203, and the second gas outlet holes 12031 are used for communicating with the first gas outlet holes 12021. The fixing plate 1202 is configured with an arc-shaped groove 12022 whose axis coincides with the rotation axis of the adjustment plate 1203. The gas outlet assembly 120 further includes an adjustment lever 1204 slidably arranged in the arc-shaped groove 12022, and one end of the adjustment lever 1204 is fixedly connected to a surface of the adjustment plate 1203 away from the heating chamber 1222 after passing through the arc-shaped groove 12022.

The implementation principle of the combi oven with smoking function in the embodiments of the present application is as follows. The grills 2 are slidably embedded into the heating chamber 1222, the oven door 11 is rotated to abut against the first seal ring 15, the latch 141 is embedded into the snap-fit slot 1100 and then rotated, so as to fix the oven door 11 relative to the outer shell 121.

When it is necessary to move the combi oven main unit 1, the handle 17 is pulled, so that the combi oven main unit 1 tilts in a direction away from the oven door 11 and the rollers 16 abut against the ground, then the handle 17 is pulled to rotate the rollers 16, so as to move the combi oven main unit 1. When moved into position, the combi oven main unit 1 is placed vertically so that the rollers 16 are off from the ground.

The above are the preferred embodiments of the present application, and the protection scope of the present application is not limited thereby, therefore, equivalent changes made according to the structure, shape and principle of the present application shall be covered by the protection scope of the present application.

### LIST OF REFERENCE SIGNS

1 combi oven main unit

11 oven door

1100 snap-fit slot

12 oven body

121 outer shell

1211 embedding groove

1212 middle housing cavity

1213 first communication groove

1214 reduced hole

1215 lower housing cavity

1216 upper housing cavity

1217 air inlet

1218 air outlet

122 inner shell

1221 mounting plate

1222 heating chamber

1223 support rail

12231 recess

1224 stop block

1225 oil discharge outlet

1226 chamfer

1227 oil discharge tube

1228 third communication hole

1229 containment groove

123 support base

124 mounting rod

125 hoop

126 filter plate

13 door limit switch

14 mounting assembly

141 latch

15 first seal ring

16 roller

17 handle

18 mounting frame

181 mounting slot

182 second communication groove

183 pressure bar

184 through slot

185 connecting bar

186 fixing block

1861 rounded corner

187 first communication hole

19 water tank

191 first grip groove

192 liquid storage chamber

193 first fixing slot

194 second communication hole

110 cover plate

1101 embedded ring

11011 annular slot

1102 third grip groove

111 second seal ring

112 grease collection tray

1121 second grip groove

1122 oil storage chamber

1123 second fixing slot

113 power board assembly

114 evaporation tray assembly

115 heating assembly

1151 electric heating tube

1152 heat spreader

11521 connecting frame

115211 sliding groove

116 illuminating lamp

117 control panel

118 heat dissipation fan

119 meat probe socket

120 gas outlet assembly

1201 gas outlet tube

12011 gas inlet

1202 fixing plate

12021 first gas outlet hole

12022 arc-shaped groove

1203 adjustment plate

12031 second gas outlet hole

1204 adjustment lever

2 grill

3 smoking box

31 storage chamber

32 stop ring

What is claimed is:

1. A combi oven with smoking function, comprising an oven body, an oven door, a plurality of grills, a heating assembly and a plurality of rollers, wherein the oven body is provided with a heating chamber on a side in a horizontal direction, the oven door is connected to the oven body and covers an opening of the heating chamber, the plurality of grills are slidably arranged in the heating chamber in the horizontal direction, the plurality of grills are distributed at intervals in a vertical direction, the heating assembly is located in the heating chamber closer to a bottom of the heating chamber than a top of the heating chamber, the plurality of rollers are connected to a lower end of the oven body, and the plurality of rollers are distributed at intervals circumferentially along the oven body.

2. The combi oven with smoking function according to claim 1, further comprising a handle, wherein the handle is connected to a side of the oven body away from the oven door, a plurality of support bases are connected to the lower end of the oven body, the plurality of support bases are distributed at intervals circumferentially along the oven body, the plurality of rollers are connected to a group of support bases of the plurality of support bases away from the oven door respectively on sides of the group of support bases away from the oven door, and a rotation axis of each of the plurality of rollers is horizontal.

3. The combi oven with smoking function according to claim 1, further comprising a gas outlet tube, wherein a lower end of the gas outlet tube extends into the heating chamber, an upper end of the gas outlet tube protrudes out of the oven body, a gas inlet is formed at an outer periphery of the lower end of the gas outlet tube, and the gas inlet is configured to connect an inside and an outside of the gas outlet tube.

4. The combi oven with smoking function according to claim 3, further comprising an adjustment plate and a fixing plate, wherein the fixing plate is coaxially embedded in the gas outlet tube, a side wall of the fixing plate fits against an inner wall of the gas outlet tube, the fixing plate is configured with a plurality of first gas outlet holes, the plurality of first gas outlet holes are uniformly distributed around an axis of the fixing plate, the adjustment plate is coaxially and rotatably embedded in the gas outlet tube, a side wall of the adjustment plate fits against the inner wall of the gas outlet tube, the adjustment plate fits against the fixing plate, the adjustment plate is configured with a plurality of second gas outlet holes, a quantity of the plurality of second gas outlet holes is equal to a quantity of the plurality of first gas outlet holes, the plurality of second gas outlet holes correspond to the plurality of first gas outlet holes one-to-one, and the plurality of second gas outlet holes are used to communicate with the plurality of first gas outlet holes.

5. The combi oven with smoking function according to claim 4, further comprising an adjustment lever located on a side of the fixing plate close to the heating chamber, the fixing plate is configured with an arc-shaped groove, an axis of the arc-shaped groove coincides with a rotation axis of the adjustment plate, the adjustment lever is slidably arranged in the arc-shaped groove, one end of the adjustment lever is connected to the adjustment plate after passing through the arc-shaped groove.

6. The combi oven with smoking function according to claim 1, further comprising a power board assembly, wherein the heating assembly comprises an electric heating tube and a heat spreader above the electric heating tube, the electric heating tube and the heat spreader are both arranged in the heating chamber, the power board assembly is connected to the oven body, and the power board assembly is electrically connected to the electric heating tube.

7. The combi oven with smoking function according to claim 6, further comprising a smoking box, wherein the smoking box is connected to the heat spreader under the heat spreader, and the smoking box is provided with a spice storage chamber.

8. The combi oven with smoking function according to claim 6, further comprising an illuminating lamp, wherein the illuminating lamp is arranged in the heating chamber, and the illuminating lamp is electrically connected to the power board assembly.

9. The combi oven with smoking function according to claim 6, further comprising a water tank and an evaporation tray assembly, wherein the water tank is connected to the oven body, the water tank is provided with a liquid storage chamber, the evaporation tray assembly is connected to the oven body, one end of the evaporation tray assembly extends into the liquid storage chamber, the evaporation tray assembly communicates with the heating chamber via a conduit, and the evaporation tray assembly is electrically connected to the power board assembly.

10. The combi oven with smoking function according to claim 1, further comprising a grease collection tray, wherein the grease collection tray is connected to the lower end of the oven body, the grease collection tray is provided with an oil storage chamber, the bottom of the heating chamber is configured with an oil discharge outlet, the oil discharge outlet communicates with the oil storage chamber, and a chamfer is formed at an inner wall of the oil discharge outlet at an end of the oil discharge outlet away from the grease collection tray.
